(19) United States
(12) Patent Application Publication
(10) Pub. No.: US 2012/0086723 A1
(43) Pub. Date: Apr. 12, 2012

(54) Dynamic Cropping of Visual Content

(76) Inventors: John Fairfield, Bridgewater, VA (US); Gregory Keim, Broadway, VA (US)

(21) Appl. No.: 12/900,894

(22) Filed: Oct. 8, 2010

(51) Int. Cl. G09G 5/00

(52) U.S. Cl. 345/620

(57) ABSTRACT

A computerized device which has access to visual content receives a crop control code associated with that content. The computerized device has a software agent which, in response to the crop control code, to cause display of a selected portion of the visual content. Preferably, the software agent interacts with the computerized device to derive information on the characteristics of a display available on the device and utilizes that information to display the selected portion of the visual content.

### BACKGROUND OF THE INVENTION

The present invention relates generally to electronic communication of visual content and, more particularly, relates to a method and apparatus for dynamically controlling the portion of visual content presented and the format of its presentation.

As used herein, “visual content” will be understood to be electronic content in the form of information that may be presented to a viewer of the display of a computerized system. As an example, it may be an image or a graphic presentation. The term “computerized device” will be understood to include not only an actual computer, such as a personal computer, but also a personal digital assistant, a smart telephone, or any other device with computing capability.

For convenience, the present invention will be disclosed in the context of a computerized teaching system, for example a foreign language teaching system. This is merely a vehicle for illustrating concepts related to the invention, without the intention of limiting it. Visual content is widely used in language teaching systems, because it facilitates the learning process. It is not uncommon, in such systems, to store a relatively complex and image and use different portions of the image in different lessons, such as language lessons, or different parts of a lesson. For example, with appropriate cropping, an image of a family showing a father, a mother a daughter and a son can also be used as an image of a boy, a girl, a woman and a man. Similarly, an image of a boy walking a dog, with appropriate cropping, can also be used as an image of a boy, a boy walking, and a boy walking a dog. At present, this is all achieved by appropriate programming of each lesson that requires an image.

A language lesson might be presented on different types of computerized devices or computerized devices with different types of displays. As a minimum, different displays will exhibit different aspect ratios. Thus, it becomes important to control image cropping during presentation of a lesson, to ensure that essential portions of an image will appear and will not be partially or entirely cut off. The manner in which an image should be displayed depends upon both the lesson with which that image is used, and the device on which it is being executed.

Again, this has been the responsibility of the programmer of the language lessons, and it becomes increasingly burdensome when different types of computerized devices and displays need to be taken into account.

Therefore, there exists a need in the prior art to provide simplified technology for dynamically cropping and controlling the display of visual content, to ensure that proper portions of the content are presented to a viewer at all times, consistent with the other information being presented, and regardless of the characteristics of the display or computerized device on which it is being viewed.

### SUMMARY OF THE INVENTION

In accordance with one aspect of the present invention, a computerized device which has access to visual content receives a crop control code associated with that content. The computerized device has a software agent which, in response to the control code, displays a selected portion of the visual content. Preferably, the software agent interacts with the computerized device to derive information on the characteristics of a display available on the device and utilizes that information to perform cropping and to display the selected portion of the visual content.

In accordance with another aspect of the present invention, a computerized device executes a primary program with which are associated a sequence of selected portions of visual content available to the device. The computerized device receives a sequence of crop control codes which are correlated, respectively, to the sequence of selected portions. The computerized device has a software agent which, responsive to the sequence of crop control codes, displays the sequence of selected portions of visual content in synchronism with the primary program.

In accordance with still another aspect of the present invention, the crop control codes may specify how an image should be displayed with a particular lesson in levels of preference, indicating what portions of the image are critical, what is preferable, and what is optimum, for example. The best possible display of that image is then executed based upon the capabilities of the display device. The same image may have different portions specified as optimum, preferable, or critical, depending upon the lesson with which the image is used. Based upon the cropping codes, any device may alter the manner in which it displays the image for optimizing such display on the device, and the device will make sure such display is in accordance with the cropping codes—that is, critical parts will be displayed, and preferable parts may be displayed if possible but not necessarily, etc.

### BRIEF DESCRIPTION OF THE DRAWINGS

The foregoing brief description and further objects, features and advantages of the present invention will be understood more completely from the following detailed description of presently preferred, but nonetheless illustrative, embodiments in accordance with the present invention, with reference being had to the accompanying drawings in which:

FIGS. 1(A) and 1(B) are images useful in describing some of the cropping concepts related to the invention;

FIG. 2 is a functional block diagram illustrating a system for dynamically cropping images which embodies the present invention;

FIG. 3 is a schematic representation of a crop control code in accordance with an embodiment of the present invention;

FIG. 4 is a flowchart illustrating the operation of a software agent in accordance with an embodiment of the present invention; and

FIG. 5 is a flowchart illustrating the operation of a software agent when different levels of cropping are provided and the agent selects the most complete level available with the existing display.

### DETAILED DESCRIPTION OF THE PREFERRED EMBODIMENT

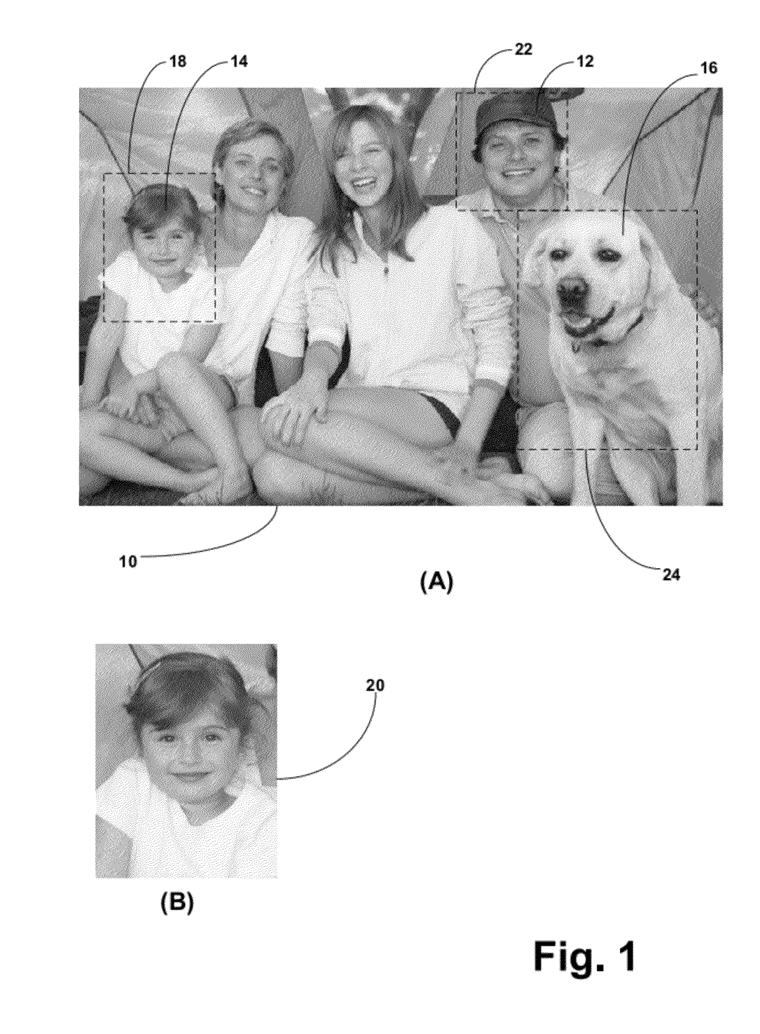

FIG. 1 (A) is an image 10 useful in describing some of the cropping concepts related to the invention. The image includes a man 12, a girl 14, and the dog 16. If, for example, image 10 were used to support a language teaching program or machine, the image could be cropped with a rectangle 18, to produce an image 20 of a girl, as in FIG. 1 (B). Similarly, image 10 could be cropped with rectangles 22 or 24 to produce an image of a man or a dog, respectively, or it could be cropped with a rectangle encompassing the man 12 and dog 16 (not shown) to produce an image of a man and dog. All of these separate images could be useful in different parts of a lesson or different lessons. However, only a single image 10 is necessary to provide images to support all of the lessons. For convenience of description, only cropping with the use of rectangles has been shown, but those skilled in the art will appreciate that cropping may be achieved with any two-dimensional shape, such as a circle, an oval a triangle or a star.

The type of cropping described in the preceding paragraph is, generally, available in the prior art. However, it was necessary to program the cropping in whatever application was using the images. Furthermore, since the application was likely to be used with different types of displays and different types of computerized devices, the programming had to take account of those differences and basically, had to customize the images for each computerized device and display. With that type of processing overhead and the continuously decreasing expense of electronic storage, it often was more practical to simply generate all of the images (original image and cropped images) for reach computerized device and simply store them.

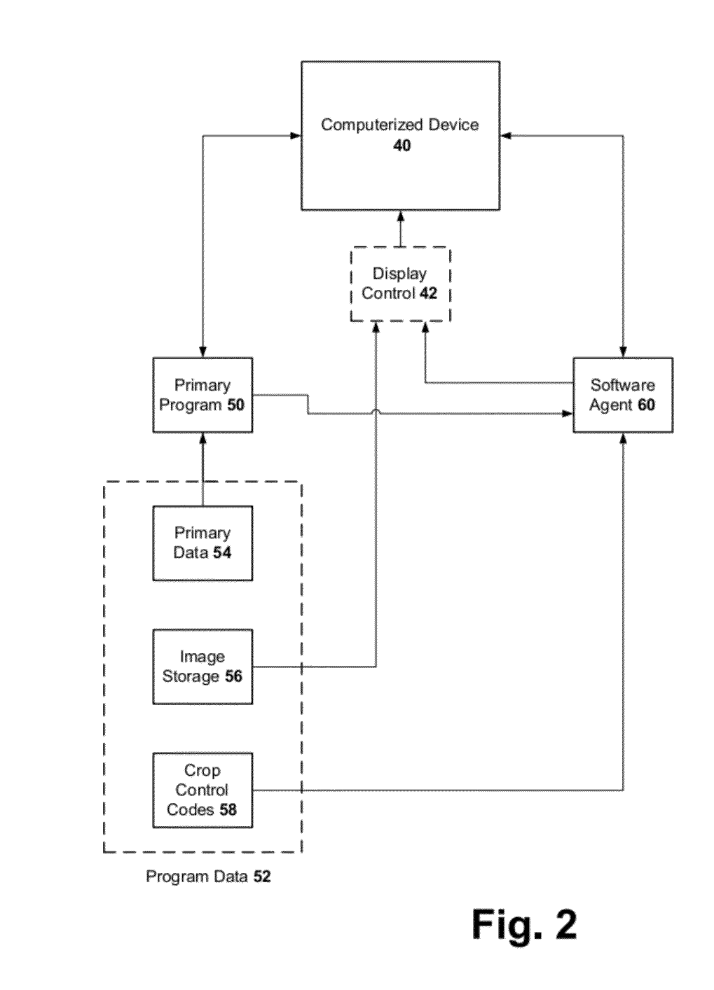

FIG. 2 is a functional block diagram illustrating a system for dynamically cropping images which embodies the present invention. A computerized device 40 is running a primary program 50, for example, a language teaching program. Program 50 will be understood to include all of the typical features of a teaching program, including a set of adaptive lessons for the student and testing capability. Program 50 includes program data 52, which includes: all of the primary data 54 for teaching a foreign language, for example German; image storage 56, which includes all of the images associated with the teaching program; and crop control codes 58, to be discussed further below.

The primary program 50 has a sequence of visual content displays associated with it. These are, for example, indicated by a sequence of interrupts in the primary data 54, each identifying and denoting the presentation of a particular visual content display. All of the information for the visual content displays is contained within image storage and 56. A visual content display may, for example, be a portion of a particular image stored in image storage 56. Crop control codes 58 comprise sequence of control codes, each corresponding to and identified with one of the interrupts in primary data 54. That is, each of the codes corresponds to one of the interrupts. Each of the crop control codes indicates a respective image in the storage 56 and contains information on the corresponding portion of that image is to be displayed. Thus, as the primary program 50 sequences through the primary data 54, the corresponding crop control codes 58 will simultaneously be addressed.

In addition to the primary program 50, computerized device 40 also runs a software agent 60. This software agent receives the sequence of crop control codes as each interrupt in the primary data 54 occurs. When a new crop control code is presented, agent 60 extracts the identity of the corresponding image and information relating to the corresponding portion of the image to be displayed, and it controls the display control 42 of computerized device 40 so as to cause it to produce a cropped image. When software agent 60 is first set up, it is provided with information about the display of computerized device 40. Thus, it will always provide display control 42 with appropriate information to crop an image correctly for the display in use.

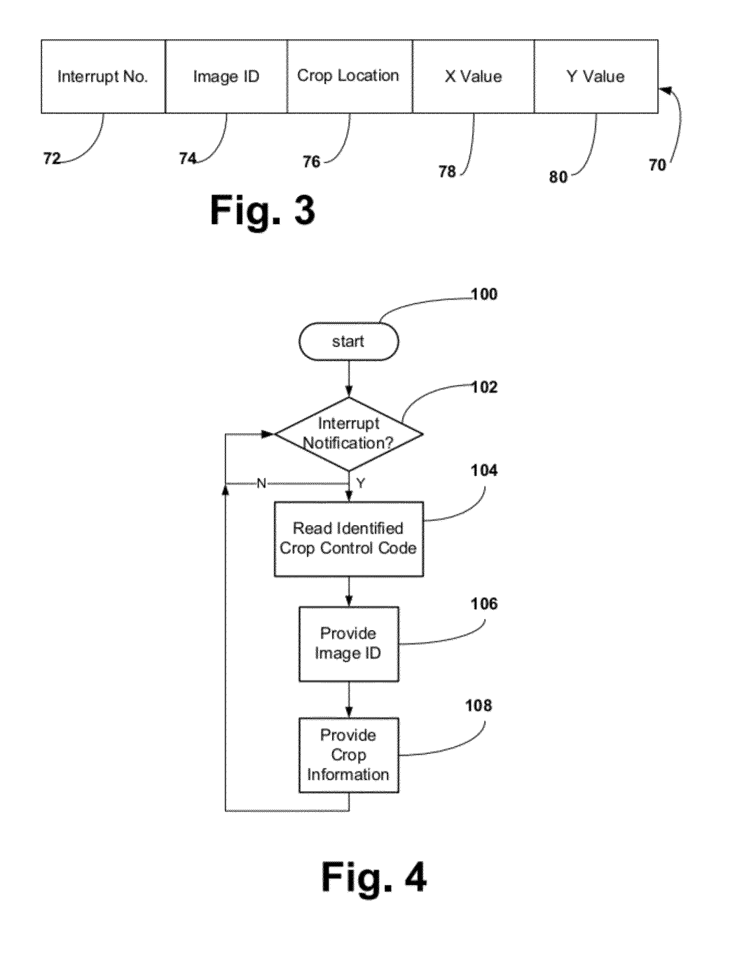

Preferably, each crop control code is comprised of alphanumeric characters, and the codes are presented either in a table or a database, for easy access. FIG. 3 is a schematic representation of a crop control code 70. Code 70 has an initial field 72 which contains the interrupt number corresponding to the image to be produced. This is basically an identification of the interrupt in the primary data which indicates that an image to be displayed. The primary program 50 presents this interrupt identification to the software agent (through device 40, although it is shown functionally as a direct connection) so the agent knows which crop control code is to be accessed. In other words, the crop control codes can be addressed via the corresponding interrupt number. The second field 74 of the crop control code contains an identification of the image in image storage 56 which is to be the source of the information for the visual content display.

Preferably, cropping is done with a rectangular shape. The third field 76 of crop control code 70 contains the crop location within the image identified in field 74. Preferably, the crop location contains the coordinates of the lower left corner of the cropping rectangle, that is, the x and y coordinates of the corner relative to a predefined origin. Fields 78 and 80 contain values corresponding, respectively, to the width (x value) and height (y value) of the cropping rectangle. Hence, fields 76, 78 and 80 together define the crop to be performed on the image identified in field 74.

FIG. 4 is a flowchart illustrating the operation of software agent 60. Operation starts at block 100. Whenever a new image is needed, primary data 54 will contain a respective interrupt. Preferably, these interrupts are simply numbered sequentially. When an interrupt is encountered, primary program 50 signals the computerized device 40 which, in turn, notify software agent 60 that an interrupt has occurred and provides the number of the interrupt. In FIG. 2, there is shown a direct connection between primary program 50 and software agent 60. However, those skilled in the will appreciate that this is merely represents a functional relationship and that the communication with software agent 60 is made through computerized device 40 as just described.

At block 102, software agent 60 awaits interrupt notification from computerized device 40. Specifically, a test is performed to determine whether an interrupt notification has been received from device 40. If not, control remains at block 102, and the test continues. If the test indicates that the notification has been received, control transfers to block 104, where agent 60 reads the crop control code that contains the interrupt number indicated by computerized device 40. At block 106, agent 60 provides the image identification in field 74 to display control 42, causing it to access the corresponding image in image storage 56. At block 108, agent 60 provides the crop information in fields 76, 78 and 80 to display control 42, causing computerized device 40 to crop the image in accordance with that information. Control then returns to block 102 to await the next notification from computerized device 40.

From the preceding disclosure it will be appreciated that the present invention makes it possible to create a dynamically cropped presentation of visual content on a computerized device, without having to program the device. By using crop codes and a software agent which responds to them, cropping can be changed by simply editing a text file. Cropping could even be changed during operation of the primary program by downloading new crop control codes or modified crop control codes to the computerized device for visual display content that is forthcoming. This makes it much easier to update lessons of even to provide customized content to a student.

It is contemplated that the cropping information contained in fields 76, 78 and 80 of a crop control code may be treated by software agent 60 as identifying a mandatory portion of an image to be displayed. That is, not every computerized device display will be able to display exactly the image indicated by the cropping information. However, software agent 60 will ensure that at least that portion of the image is displayed, although it may be desirable to display additional portions for a particular type or shape of display.

Inasmuch as software agent 60 will be set up with respect to the particular computerized device and its display, it is contemplated that the agent may be configured to permit some distortion of an image or to prohibit distortion, depending upon the needs of the primary program.

It is also contemplated that multiple “levels” may be included in the cropping code, namely, that the cropping code may include plural possibilities for cropping and displaying the image, and the best one possible is chosen. For example, the crop control codes may specify how an image should be displayed with a particular lesson in levels of importance, which indicate what is critical, what is preferable, and what is optimum. The best possible display of that image is then executed based upon the capabilities of the display device, being certain to display the critical portion and providing the preferable or optimum displays, in that order, when possible. The same image may have different portions specified as optimum, preferable, or critical, depending upon the lesson with which the image is used.

One way to achieve this would be to provide multiple cropping entries in the crop control code of FIG. 3, each with a preference level, crop location, X value and Y value. Software agent 60 would then determine the availability of each cropping entry with the existing display and display the most complete (lowest level) cropping entry possible on that particular device.

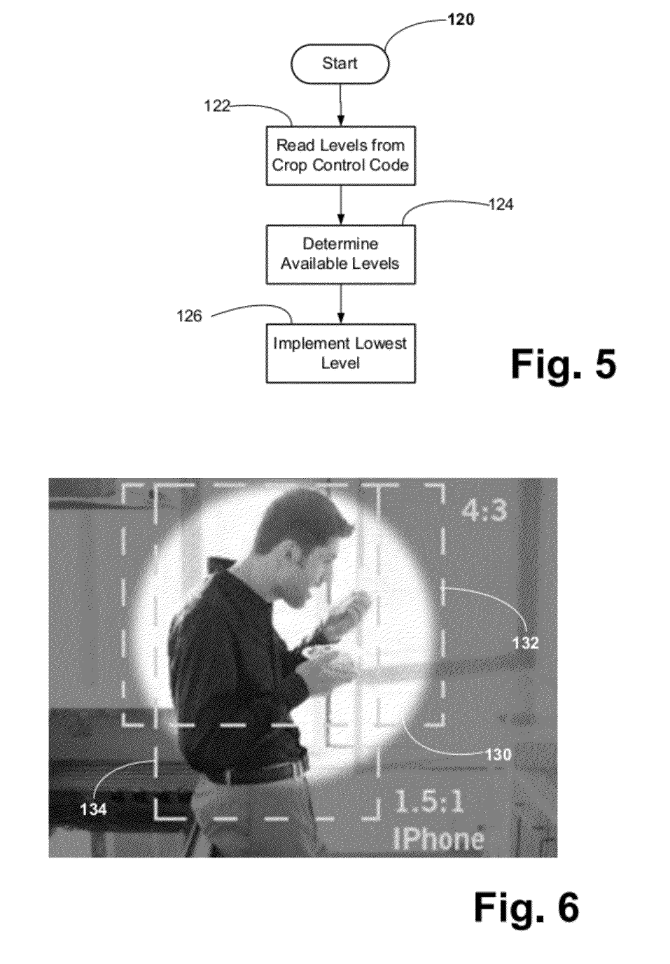

This process is exemplified by the flow chart of FIG. 5, which starts at block 120. At block 122, the preference levels of each cropping entry are read, at block 124, the availability of each cropping entry is determined, and the lowest (most complete) level of available cropping is implemented at block 126.

Although the invention has been described with reference to a primary program which is part of a teaching system, those skilled in the art will appreciate that it will find practical application in many other types of primary programs. In fact, the primary program can simply be a counter in the computerized device 40 which presents a series of “interrupts.” A series of crop control codes can then be created to produce a series of images in a kind of slide show.

Additionally, a database can be constructed which includes each image and a set of crop control codes that vary based upon the purpose of the image—in the above example, which lesson is being used in conjunction with the image. More generally, the cropping control codes, or the manner of display, may depend additionally upon audio or textual information used with the image.

Another variant may involve cropping and/or other display parameters. For example, the same methodology can be used to specify color or black and white, high, intermediate, or low resolution, or any of a variety of other display parameters.

Although preferred embodiments of the invention have been disclosed for illustrative purposes, those skilled in the art will appreciate that many additions, modifications, and substitutions are possible, without departing from the scope and spirit of the invention as defined by the accompanying claims.

What is claimed:

1. A method for dynamically cropping visual content available to a computerized device, comprising the steps of:
providing to the computerized device a crop control code identifying at least a portion of the visual content and specifying cropping to be performed to the visual content to produce a cropped visual content display; and
running a software agent in the computerized device which, responsive to the crop control code, causes the computerized device to act on the identified visual content to produce the cropped visual content display.

2. The method of claim 1 wherein the software agent includes executable code which interacts with the computerized device to derive information relating to characteristics of display means being used with the computerized device, the software agent utilizing the derived information to control the cropping to be imparted to the identified visual content.

3. The method of claim 1 wherein the software agent causes the computerized device to display cropped visual content, but permits it simultaneously to display some additional content.

4. The method of claim 1 wherein the software agent causes the computerized device to display cropped visual content, but permits some distortion of thereof.

5. The method of claim 1 wherein the crop control code contains a plurality of cropping entries representing different possible croppings of the visual content and the software agent selects one of the cropping entries based on predefined information.

6. The method of claim 5 wherein the crop control code contains a level code for each cropping entry representing the preferability of a respective one of the possible croppings, the predefined information including the level codes.

7. The method of claim 6 wherein preferability of a cropping decreases as it includes more of the visual content, the software agent selecting a cropping based on preferability.

8. Apparatus for dynamically cropping visual content available to a computerized device containing display means for visual content, comprising:
means in said computerized device storing a crop control code identifying at least a portion of the visual content and specifying cropping to be performed to the visual content to produce a cropped visual content display; and
a software agent running in the computerized device which, responsive to the crop control code, causes the computerized device to act on the identified visual content to produce the cropped visual content display.

9. The apparatus of claim 8 wherein the software agent includes executable code which interacts with the computerized device to derive information relating to characteristics of the display means being used with the computerized device, the software agent utilizing the derived information to control the cropping to be imparted to the identified visual content.

10. The apparatus of claim 8 wherein the software agent causes the computerized device to display cropped visual content, but permits it simultaneously to display some additional content.

11. The apparatus of claim 8 wherein the software agent causes the computerized device to display cropped visual content, but permits some distortion of thereof.

12. The apparatus of claim 8 wherein the crop control code contains a plurality of cropping entries representing different possible croppings of the visual content, the software agent selecting one of the cropping entries based on predefined information.

13. The apparatus of claim 12 wherein the crop control code contains a level code for each cropping entry representing the preferability of a respective one of the possible croppings, the predefined information including the level codes.

14. The apparatus of claim 13 wherein preferability of a cropping decreases as it includes more of the visual content, the software agent selecting a cropping based on preferability.

15. A method for controlling a computerized device executing a primary program with which are associated a sequence of selected portions of visual content available to the device, the method producing dynamic cropping of the visual content and comprising the steps of:
providing to the computerized device a sequence of crop control codes which are correlated, respectively, to the sequence of selected portions, each crop control code identifying a portion of the visual content and specifying cropping to be performed thereto to produce a cropped visual content display of that portion which is part of the sequence of selected portions; and
running a software agent in the computerized device which, in responsive to the sequence of crop control code, causes the computerized device to act on the identified visual content to produce a cropped visual content display containing the sequence of selected portions of visual content in synchronism with the primary program.

16. The method of claim 15 wherein the software agent includes executable code which interacts with the computerized device to derive information relating to characteristics of display means being used with the computerized device, the software agent utilizing the derived information to control the cropping to be imparted to visual content.

17. The method of claim 15 wherein the software agent causes the computerized device to display cropped visual content, but permits it simultaneously to display some additional content.

18. The method of claim 15 wherein the software agent causes the computerized device to display cropped visual content, but permits some distortion of thereof.

19. The method of claim 15 wherein a crop control code contains a plurality of cropping entries representing different possible croppings of the visual content and the software agent selects one of the cropping entries based on predefined information.

20. The method of claim 19 wherein a crop control code contains a level code for each cropping entry representing the preferability of a respective one of the possible croppings, the predefined information including the level codes.

21. The method of claim 20 wherein preferability of a cropping decreases as it includes more of the visual content, the software agent selecting a cropping based on preferability.

22. The method of claim 21 wherein the software agent includes executable code which interacts with the computerized device to derive information relating to characteristics of display means being used with the computerized device, the software agent utilizing the derived information together with preferability to control the cropping to be imparted to visual content.

23. The method of claim 22 wherein the software agent controls cropping so as to impart cropping with the lowest preferability consistent with the derived information.

24. Apparatus for controlling a computerized device executing a primary program with which are associated a sequence of selected portions of visual content available to the device, to produce dynamic cropping of the visual content, comprising:
means in said computerized device storing a sequence of crop control codes which are correlated, respectively, to the sequence of selected portions, each crop control code identifying a portion of the visual content and specifying cropping to be performed thereto to produce a cropped visual content display of that portion which is part of the sequence of selected portions; and
a software agent running in the computerized device which, responsive to the sequence of crop control codes, causes the computerized device to act on the identified visual content to produce a cropped visual content display containing the sequence of selected portions of visual content in synchronism with the primary program.

25. The apparatus of claim 24 wherein the software agent interacts with the computerized device to derive information relating to characteristics of display means being used with the computerized device, the software agent utilizing the derived information to control the cropping to be imparted to visual content.

26. The method of claim 24 wherein the software agent causes the computerized device to display cropped visual content, but permits it simultaneously to display some additional content.

27. The apparatus of claim 24 wherein the software agent causes the computerized device to display cropped visual content, but permits some distortion of thereof.

28. The apparatus of claim 24 wherein a crop control code contains a plurality of cropping entries representing different possible croppings of the visual content, the software agent selecting one of the cropping entries based on predefined information.

29. The apparatus of claim 28 wherein a crop control code contains a level code for each cropping entry representing the preferability of a respective one of the possible croppings, the predefined information including the level codes.

30. The apparatus of claim 29 wherein preferability of a cropping decreases as it includes more of the visual content, the software agent selecting a cropping based on preferability.

31. The apparatus of claim 30 wherein the software agent interacts with the computerized device to derive information relating to characteristics of display means being used with the computerized device, the software agent utilizing the derived information together with preferability to control the cropping to be imparted to visual content.

32. The apparatus of claim 31 wherein the software agent controls cropping so as to impart cropping with the lowest preferability consistent with the derived information.

33. A method comprising
transmitting data related to a lesson to be taught to a student on an electronic device of a particular type;
determining how to display an image associated with said data, wherein said determining is based at least upon said particular type and said data; and
displaying the image as determined.

34. The method of claim 33 wherein said step of determining includes determining how to crop said image.

35. The method of claim 33 wherein said step of determining includes determining how a resolution associated with said image.

36. The method of claim 33 wherein said step of determining includes transmitting crop codes from a remote location to a display device.

37. The method of claim 33 wherein a crop control code contains a plurality of cropping entries representing different possible croppings of the visual content and the software agent selects one of the cropping entries based on predefined information.

38. The method of claim 37 wherein a crop control code contains a level code for each cropping entry representing the preferability of a respective one of the possible croppings, the predefined information including the level codes.

39. The method of claim 38 wherein preferability of a cropping decreases as it includes more of the visual content, the software agent selecting a cropping based on preferability.

40. The method of claim 39 wherein the software agent includes executable code which interacts with the computerized device to derive information relating to characteristics of display means being used with the computerized device, the software agent utilizing the derived information together with preferability to control the cropping to be imparted to visual content.

41. The method of claim 40 wherein the software agent controls cropping so as to impart cropping with the lowest preferability consistent with the derived information.

42. A method comprising designating each of plural portions of an image with a cropping code to produce a plurality of cropping codes indicative of the criticality of the portions of said image, and processing said image to display it in a manner dependent upon both said cropping codes and a device upon which said image is to be displayed.

43. The method of claim 42 wherein said device is further dependent upon textual information accompanying said image.

44. The method of claim 43 wherein said display is further dependent upon audio information accompanying said image.
